(19) United States
(12) Patent Application Publication
(10) Pub. No.: US 2006/0275528 A1
(43) Pub. Date: Dec. 7, 2006

(54) Perimeter enhancement on edible products

(76) Inventors: Thomas Collins, Nazareth, PA (US); Arun Shastry, Neshanic Station, NJ (US); Jeannette Hainzl, Morristown, NJ (US); Puja Minotti, Saxton Drive, NJ (US)

Correspondence Address: FITZPATRICK CELLA HARPER & SCINTO, 30 ROCKEFELLER PLAZA, NEW YORK, NY, 10112, US

(21) Appl. No.: 10/547,537

(22) PCT Filed: Mar. 5, 2004
(86) PCT No.: PCT/US04/07129

§ 371 Date: Aug. 2, 2006

Related U.S. Application Data
(60) Provisional application No. 60/452,895, filed on Mar. 7, 2003.

(51) Int. Cl. A23P 1/00

(52) U.S. Cl. 426/87; 426/89; 426/383

(57) ABSTRACT

The present invention is directed to a decorated edible product comprising: an intermediate product having a surface, an edible image printed on the surface of the intermediate product, and an image enhancing border positioned within or adjacent to the edible image.

### BACKGROUND OF THE INVENTION

1. Field of the Invention

The present invention is directed to decorated edible products having an edible image printed on a surface thereon. More particularly, the present invention is directed to a decorated edible product and methods of making such a product having an edible image printed on a surface of the product, wherein an image enhancing border is positioned within or adjacent to the image.

2. Related Background Art

The placement of pictorial or graphical images on food products is known in the art. The appearance of a graphical image distinguishes the food product from others by providing it with a decorative or informational feature. Manufacturers have used various means to achieve this desired look. For example, U.S. Pat. Nos. 4,905,589; 5,433,146; and 5,655,453 disclose various means and methods for imprinting pellet shaped articles, such as pharmaceuticals or confectionery pieces. Furthermore, U.S. Pat. No. 5,800,601 describes ink jet compositions that are suitable for printing messages on edible or ingestible materials. Printing attractive colored images or phrases on the non-planar surfaces of sugar shell confectionery, such as M&M's® Milk Chocolate and Peanut Chocolate Candies poses a particular challenge. Especially when the background surface is strongly colored, e.g., having a dark colored background. Colors printed on these surfaces often do not appear distinctly enough against the strong colored background.

There are several factors that influence the perception of color on an object. One factor is the lighting which illuminates the object. Another is the object upon which the color is placed. Its shape and how it reflects light. A third factor is the individual observing and sensing the color. Other elements that also influenced how a color is perceived, are other colors surrounding or nearby, adjacent to, etc.

Colors have been identified and characterized in many different ways. Typically, a grouping of all possible colors is arranged and categorized in some fashion so that a relationship is established between colors.

Printed colors are generally most noticeable when the color is printed using a pigmented ink, which provides the desired opacity. However, by their nature pigmented inks are known to be viscous and difficult to work with.

While the prior art methods may be capable of producing printed images on edible products, artistic styling associated with brightly colored images is often lacking. Often the images are applied onto the product's surface in an unimaginative fashion. Typically, the solution is to use white ink on colored candy or colored inks on white candy. To capture the consumer's interest, artistic styling of the edible images would be highly desirable, particularly if such styling could be obtained on colored edible products, including colored edible products which have non-porous hydrophobic surfaces which are difficult to print on.

### SUMMARY OF THE INVENTION

The present invention is directed to a decorated edible product comprising an intermediate product having a surface, an edible image printed on the surface of the intermediate product, and an image enhancing border positioned within or adjacent to the edible image. The border advantageously enhances the color in the edible image. A particularly preferred edible product is a pellet shaped edible product, more preferably a sugar shelled lentil or oval shaped confectionery.

The present invention also includes a method for making a decorated edible product, comprising the steps of: (a) providing an intermediate product; (b) printing an edible image on at least a portion of a surface of the intermediate product; and (c) applying an image enhancing border on at least a portion of the surface of the intermediate product, wherein the border is positioned within or adjacent to the edible image. The present invention provides a means for preparing edible products having particularly vibrant and stylistic images even on non-planar surfaces of edible products, including confectionery pieces having non-porous hydrophobic surfaces.

### DETAILED DESCRIPTION OF THE INVENTION

For the purposes of the present invention, the term “border” is meant to describe a boundary that partially or completely surrounds or is surrounded by an image. The border is typically applied by printing with edible ink. It may be applied at the same time as the image is printed or applied in a separate step. The border could also be formed by the application of an image enhancing background, as described in co-pending U.S. patent application, titled “Multicolored Image Optimization On Edible Colored Products,” prior to application of the image in a manner in which the background slightly extends beyond the area of the printed image.

For the purposes of the present invention, the phrase “true color” is used to describe a color that has the proper intensity and tone when applied. Color is defined in terms of hue, value and chroma Hue represents the color family. For example, the surface may have a hue of orange, blue, red, etc. Value represents the lightness or darkness of the color. The brighter a color is, the higher is its value and the more light it emits. Chroma is the strength or intensity of the color. It is an indication as to how different a pure hue is from a gray shade. Colors with strong chroma are considered bright and saturated. Colors with low chroma are considered dull.

Tint and Shade describe the variation of a given color from the original hue. For example, if white paint is added to a dark red paint, the lighter version of the red color is now called a tint of the original red. Similarly, when black is added to a color, the new color is called the shaded version of the original color.

For the purposes of the present invention, the term “enhanced color” is meant to describe a color that is perceived to be a truer color when viewed by an observer. The truer color has a hue, value and/or chroma that directionally moves closer to the true color, e.g., Munsell Color System value.

For the purposes of the present invention, the term “vignette” refers to a visual effect where part of an image has been altered so that the density of the ink droplets that create the image is decreased at an edge thereof, creating the impression that the image is fading or blending into a different part of the image or background.

For the purposes of the present invention, the term “emphasized” refers to a visual effect where part of an image or background has been altered so that that part of the image stands out relative at an edge thereof to the background surface.

For the purposes of the present invention, the term “perimeter” refers to a boundary that defines the inner or outer limits of an image on a background surface. For example, one or more edges may form the perimeter surrounding an image. In some instances, an image may have more than one perimeter, where for example, the image is shaped with an inner perimeter and an outer perimeter.

For the purposes of the present invention, the term “chocolate” refers to milk chocolate, dark chocolate, white chocolate, or any non-standard of identity (SOI) chocolate that mimics the look of SOI milk chocolate or dark chocolate.

In addition, for the purposes of the present invention, the term “image” refers to any picture or pictorial image, pattern, symbol, text or alphanumeric character or group of characters.

When a color is observed against a colored background, the color may be adversely affected by the contrasts in hue, value, and chroma. For example, a light colored background with a dark colored image, will make the dark colored image appear even more darker. While a dark colored background with a light colored image, will make the light colored image seem more lighter.

In one aspect of the invention, an image enhancing border is positioned within or adjacent to an image to provide a complementary contrast that enhances the colors of the image. Ideally, the presence of the border brings out the true colors of the image. The border distinguishes the background color from the image color by providing a break between the two colors. This break, helps the observer to see the truer color of the image. The edible image is printed using one or more edible inks. In many instances, the edible inks are applied onto colored surfaces that distort the true color of the edible inks. The image enhancing border serves to assist in bringing out the true colors of the edible inks used to create the image. This is accomplished by emphasizing the border in various ways. For example, the border may be a colored border that provides a complementary contrast with the colors in the image or background. Preferably, the colored border is an opaque color and/or of noticeable width. Alternatively, the image enhancing border may provide a feathering effect to emphasize or de-emphasize a portion or substantially all of the edible image. The vignetted border may be positioned within or adjacent to the edible image. Moreover, it may be used to create an artistic look.

A useful method of evaluating colors is the Munsell Color System. This method is widely used by artists, designers, and others who require a less ambiguous way of describing colors. Munsell identifies colors based upon three attributes, hue, value, and chroma. Each color is then given an alpha numerical value.

Hue identifies the family of the color. The major family of hues includes red, yellow, green, blue, and purple. The minor family of hues are orange (yellow-red), green-yellow, blue-green, purple-blue, and red-purple. In the Munsell System, there are ten hue families presented in a color wheel. The ten hue families are each further divided into ten subfamilies. The true hue for a family is at the center and assigned the number 5. The number 10 is assigned to the hue that is halfway between two adjacent true hue families.

Value characterizes the lightness or darkness of a color. Sometimes the value is thought of in terms of tints or shades. Tints are thought of as light colors, for example, colors to which white color has been added. While shades are thought of as dark colors. Neutral colors have no hue and are designated by an N and an integer and a slash. For example, absolute black is noted as N 0/. Thus changes in value from black to white can be characterized using the Munsell system.

Chroma is the strength or intensity of a color. It can be used to distinguish a strong color from a weak color. Strong, vivid, or highly saturated colors have a high chrome While colors that are considered weak or dull have a low chroma. Another way of understanding chroma is that it is the difference from a pure hue to a gray shade.

To select the color of the border, the following procedure is used. Step One. The “true color” is determined using a color categorizing system, such as the Munsell Color System. Step Two. A visual determination is made as to which color represents how the color in the printed image appears. Step Three. A determination is made as to how the color selected in step 2 should be adjusted to move closer to the ‘true color.’ This is somewhat dependent upon the desired result. For example, (a) to make the color appear lighter, increase the Value by using a dark/darker border; (b) to make the color appear darker, decrease the Value by using a light/lighter border; (c) to increase Saturation, use a light/lighter border; and (d) to decrease Saturation, use a dark/darker border.

In general, for a (A) light colored background with a light colored image, the image will appear darker by increasing the color saturation, therefore a dark colored border should be used; (13) dark colored background with a light colored image, the image will appear lighter by decreasing the color saturation, therefore a light colored border should be used; (C) dark colored background with a dark colored image, the image will appear lighter by decreasing the color saturation, therefore a light colored border should be used; and (D) light colored background with a dark colored image, the image will appear darker by increasing the color saturation, therefore a dark colored border should be used.

A simple experiment was performed to demonstrate the influence that a white or black border has on the perception of a magenta colored image. Seven graphic representations were created, labeled 1 through 7. The representations may be found in U.S. Provisional Patent Application Ser. No. 60/452,895 filed Mar. 7, 2003, the disclosure of which is incorporated by reference herein. In each of the graphic representations, a magenta colored image having the shape of a 2.5 cm×2.5 cm square was printed inside a 5 cm×5 cm colored background square on white colored paper. In graphic representation 1, the background was yellow and the image was surrounded by a 1 mm white border. In graphic representation 2, the background was cyan and the image surrounding border was a 0.5 mm black border. In graphic representation 3, the background was cyan and no border was used. In graphic representation 4, the background was cyan and the image was surrounded by a 1.5 mm white border. In graphic representation 5, the background was cyan and the image surrounding border was a 0.5 mm white border. In graphic representation 6, the background was yellow and the image was surrounded by a 0.5 mm black border. In graphic representation 7, the background was cyan and the border surrounding the image was black and 0.25 mm thick.

A color chart for magenta was assembled for comparison purposes. The chart was assembled with a pure magenta rectangle placed in the upper right corner of the chart. Moving to the left of the pure magenta rectangle were magenta rectangles of lighter tints and decreasing value. Moving downward from the pure magenta rectangle, were magenta rectangles of darker shades of magenta, indicating increasing value. Each magenta rectangle represented approximately a 10% change in value from the rectangle adjacent to it. For example, directly below the pure magenta rectangle was a darker shaded magenta rectangle, which was about 100% magenta and about 10% black.

Four individuals compared graphic representations 1 through 7 against the magenta color chart described above. A grading was assigned to each graphic representation based upon where the image color in the graphic representation fell on the magenta color chart. Their observations and grading are summarized in Table 1:

TABLE 1

| Background | Foreground | Border | Border | | Results | |
|---|---|---|---|---|---|---|
| Color | Color | Color | Thickness | | (avg. of 4 observers) | Comments |
| 100% Yellow | 100% Magenta | White | 1 | mm | Grading: (H) | This treatment made the |
| | | | | | 100% Magenta and 10% Black | magenta appear lighter than |
| | | | | | | in treatment 6 |
| 100% Cyan | 100% Magenta | Black | 0.5 | mm | Grading: To the | This is the only option that |
| | | | | | lower left corner of (A) | improved the appearance of |
| | | | | | 95% Magenta and 5% Black | the magenta, it is closest to |
| | | | | | | the ‘true color’ A (100% |
| | | | | | | magenta) which is the goal color |
| 100% Cyan | 100% Magenta | None | ** | | Grading: (H) | This is the unaltered sample |
| | | | | | 100% Magenta and 10% Black | that which we want to improve |
| 100% Cyan | 100% Magenta | White | 1.5 | mm | Grading: between (H) and (I) | This actually made the |
| | | | | | 100% Magenta and 15% Black | magenta look darker |
| 100% Cyan | 100% Magenta | White | 0.5 | mm | Grading: (I) | This was the worst treatment |
| | | | | | 100% Magenta and 20% Black | making the magenta look |
| | | | | | | significantly darker |
| 100% Yellow | 100% Magenta | Black | 0.5 | mm | Grading: between (H) and (I) | This made the magenta look |
| | | | | | 100% Magenta and 15% Black | darker than treatment 1 |
| 100% Cyan | 100% Magenta | Black | 0.25 | mm | Grading: (H) | showed no improvement |
| | | | | | 100% Magenta and 10% Black | |

Graphic representation 3, represented the unaltered sample, which was determined to fall directly below the pure magenta rectangle. The best results were observed in graphic representation 2, which was placed on the chart in the lower left corner of the pure magenta rectangle. In graphic representation 2, the 0.5 mm black border enhanced the color appearance of the magenta colored image, bringing it closer to its true color.

The border may partially or substantially surround the image. In a preferred embodiment, the border completely surrounds the image. In another embodiment, the border may be within the edible image, i.e. surrounded by the edible image. For example, the image may have a donut-like shape.

The width of the border will be determined by various factors, including for example, (a) the size of the product, (b) the size of the edible image, (c) the artistic affect that is desired, and (d) the perceived degree of color distortion. Generally, the width of the border is greater than about 0.1% and less than about 20% of the longest dimension of the image. Preferably between about 1% and 10% of the longest dimension of the image and more preferably between about 2% and 8% of the longest dimension of the image.

When printing on colored surfaces, e.g., confectionery pieces, to make the color of the printed image appear its true color on a given background, a border is positioned within or adjacent to the image. The optimum color for the border is adjusted depending on the color of the image and the color of the background.

The border will typically separate the edible image from the background. In addition, the border may be emphasized through the use of one or more colors and/or by varying the width of the border. In one preferred embodiment, the border is a white or gray scaled color.

Alternatively, the image enhancing border may be used to provide an enhancing effect on at least a portion of the perimeter surrounding an edible image, thereby drawing attention to a focal point in the image. For example, an image that is surrounded by a perimeter may be partially or fully vignetted. Typically, the image will be surrounded by four side edges which make up the perimeter, although clearly more or less edges are possible depending on the image. One or more of the side edges may be vignetted and each side may be partially or fully vignetted. Alternatively, the image may be surrounded by a soft edge, e.g., a circle, an oval or other rounded shape. Enhancement of the image can be achieved by feathering at least a portion of the soft edge.

As noted above, the image enhancing border may provide a vignette appearance around a portion or all of the edible image. The vignette appearance is created by gradually reducing the dots per unit area of the image. For instance, by using an ink jet printer, the density of the ink matrix can be varied so that the number of dots per inch (dpi) can be reduced from for example, 400 dpi down to about 10 dpi. For the appearance of a vignette edge or perimeter, the background or image resolution is decreased. Typically, less than about 300 dpi, and preferably a range of about 200 dpi to about 40 dpi, is used to create the vignette edge or perimeter appearance. The less dense matrix reduces the resolution and softens the image.

In another embodiment, the use of a background surface having a vignette edge advantageously reduces the sharpness of the background surface, such as the color enhanced image coating described in co-pending U.S. patent application (Attorney Docket No. 02280.003550), titled “Multicolored Image Optimization On Edible Colored Products,” filed contemporaneously. In addition, it may be preferable to round the corners of the background surface. It may also be preferable to round the corners of the edible image to reduce the sharpness of the edge of the image. In a preferred embodiment of the invention, the edible image encompasses the entire area of a vignette background surface. It has also been found that printing the image to correspond to the perimeter of the vignette background surface results in a printed edible image that provides the impression of particularly vibrant colors on the background surface. In a particularly preferred embodiment, an edible image having a vignetted or faded edge is superimposed over a background surface having a vignette edge.

A variety of affects are created through the use of the image enhancing border. In one embodiment, where the border provides a vignetting effect, the image has the appearance that the image flows into the background. A different visual impression can be created by vignetting the portion of the background that contacts the image, creating the appearance that the background fades into the image. Or the outer perimeter of the background surface may be vignetted creating a halo appearance around the whole product. The vignetting of an area may also be done in the shape of a pattern. Any pattern may be used.

In addition, the printed edible image may be modified. For example, the color intensity or tone of the image may be increased or decreased. Or the image colors may be changed. Modifications may be made to achieve the desired visual effect.

Other methods may also be employed in conjunction or independent of the method taught in the present invention for providing truer image color. Enhancement of the image color may be accomplished through various means, such as those described in co-pending U.S. patent application (Attorney Docket No. 02280.003550), titled “Multicolored Image Optimization On Edible Colored Products,” filed contemporaneously, which teaches the use of a color enhancing coating/substrate, which is applied to the surface of an edible product. An image is then printed on at least a portion of the color enhancing substrate. The color enhancing substrate provides sufficient opacity to block the effects of the underlying background surface color, which may detrimentally affect the image's color. The color enhancing substrate may also be used to form a border. For example, the color enhancing substrate can be applied such that a portion of the substrate will extend slightly beyond the area of the edible printed image, prior to application of the image.

The edible product may be, for example, any food, confectionery, pharmaceutical, and the like. Non-limiting examples of the edible product are molded chocolates, enrobed chocolates, baked products, sugar-based products, gums, pet foods, main meal and snack food products, pharmaceutical products, vegetables, fruits, produce, meat, poultry, eggs, dairy products, frozen foods, ice creams, and fried products. The preferred edible product is a confectionery piece having a polished sugar shell.

The intermediate product is the edible product prior to decoration by the method of this invention. The intermediate product has a surface that is, for example, a carbohydrate based material, a hydrophobic based material, a proteinaceous based material, or a pharmaceutical based material. Carbohydrate based materials include, but are not limited to, sugar compounds, glazes, gelatin, maltodextrins, shellac, gum arabic, dextrin, and the like. Non-limiting examples of hydrophobic based materials are, polishes such as carnauba wax, candililla wax, beeswax, fats,and the like. Proteinaceous materials are, for example, food proteins and protein extracts such as gelatin, whey protein, milk caseins, albumins, plant proteins such as soy proteins, peptide fragments of animal and plant source such as hydrolyzed proteins, and can also include simple amino acids and the like. Suitable pharmaceutical based materials include, for example, pharmaceutical grade ingredients, colorants, binders, film formers, and the like. Preferably, the background surface is comprised of a sugar compound, e.g., sugar shell coating which has been polished with a wax. In addition to intermediate products having a colored background, some intermediate products may have colored pearlescent finishes which provide a metallic-look to the appearance of the product. Materials that can be used in applying pearlescent or metallic finishes to coated confectionery or pharmaceutical tablets include a mica-based product called Candurin®, which is available from Merck and Company.

The image enhancing border and edible image may be applied using various printing techniques. Suitable methods of printing include, pad printing, stamp printing, hand printing, ink jet printing, spraying, roller coating, air brushing, etching, laser printing, offset rotogravure, flexographic, gravure printing processes and the like.

Ink jet printing involves the production of tiny droplets of ink that are fired by a jet mechanism to a substrate, such as a background surface, to form a printed primary image. Piezo jet, continuous jet, and thermal jet methods are widely known and used. A typical commercially available ink jet printer has 4 ink jets individually containing 3 complementary colors and black to allow the production of a broad range of colors. In a preferred embodiment according to the invention, the printhead includes a white ink print engine substituted for the conventional black print engine, and at least one non-pigmented edible ink print engine. The white ink will typically be pigmented. In a most preferred embodiment, the white ink print engine is combined with cyan, magenta, and yellow print engines supplied with non-pigmented water based inks. Use of a three color printing system such as cyan, magenta, and yellow (CMY) to create all colors in an image (e.g., orange created from mixing droplets of magenta and yellow) is known as process printing. Another embodiment of the invention uses line printing where the print engines will hold pre-prepared specific colors (e.g., orange). However, a white pigmented edible ink reservoir and at least one non-pigmented edible ink reservoir is preferred. Moreover, color printers having as few as 3 ink colors or as many as 12 colors are available. Ink jet printing on edible products is disclosed in co-pending application Ser. Nos. 10/211,592 filed Aug. 5, 2002 and Ser. No. 09/587,108, filed Jun. 2, 2000, which are incorporated by reference.

Inkjet printing systems are broadly divided into continuous jet, and drop-on-demand (also called “impulse”) systems in which droplets are generated as needed for ejection to the background surface for image formation. Methods of ink-jet printing on edible substrates using continuous jet technology are known. Most of these are directed to labeling and the like applications which do not require high resolution.

In continuous jet systems, ink is emitted in a continuous stream under pressure through at least one nozzle. The stream is broken up into droplets at a fixed distance from the orifice, typically, by a piezoelectric crystal, which is vibrated at controlled frequency adjacent to the ink stream. To control the flow of ink droplets, these inks are charged (by addition of salts and other conductive agents) and the droplets are passed through an electrostatic field, which adjusts the trajectory of the droplets, in accordance with digital data signals. The droplets are either directed back to a gutter for recirculation or to a specific location on the substrate to create the desired character matrix. A typical resolution for a continuous jet printer image in an industrial setting, using a single printhead and a single pass printing is about 70-90 dpi.

Preferably, the high resolution ink jet printed primary image is deposited using drop on demand inkjet printing methods such as, for example, piezo jet printing. The resulting black or colored image typically has a resolution of at least 100 dots per square inch (dpi), preferably 200 dpi, and more preferably in a range of about 300 dpi to about 1200 dpi, and most preferably in a range of about 300 dpi to about 800 dpi.

Any edible ink may be used to form the edible image. Edible inks include, for example, wax based inks, water based inks, solvent based inks, and inks comprising pigments or lakes. Water based inks are preferred. In a preferred embodiment, the edible image is a high resolution ink jet printed image comprised of at least one white, black or colored food grade ink. Generally, the image will be comprised of a plurality of edible food grade inks. Typically, the edible food grade inks will include cyan, magenta, yellow and black or white inks.

It should be noted that the edible image to be printed, i.e., either a white image, black image or a colored image, can be derived from any analog or digital source, e.g., a computer hard drive, scanner, digital camera or over the internet. Systems for providing digital images to ink jet systems are described, for example, in co-pending U.S. patent application Ser. No. 09/587,108. Fading or feathering the image at the perimeter thereof may be performed by using available computer image-processing software. In a preferred embodiment, an ink jet printed edible image having a vignette perimeter is combined with and positioned over an edible image-enhancement coating having a vignette perimeter where both the image and the substrate coating have substantially the same dimensions.

In another preferred embodiment, the ink jet printed primary image may be formed on a portion of the edible image-enhancement coating or, if desired, may be formed on substantially all of the edible image-enhancement coating. The edible image-enhancement coating is at least a part of the intermediate product surface and is used to provide a neutral background color upon which the image is laid, which helps bring out the true color of the image.

The edible image may be treated after printing to provide protection from abrasion and/or enhancement of the image quality. The treatment may include application of a glossy coat, a moisture barrier coat, a wax, or may be printed with other edible inks using screen printing or other printing technologies. Preferably, color images are applied by overlaying inks of different colors. The printed surface may be treated with protective coatings such as, for example, sugar compounds, glazes, gum arabic, dextrin, carnuba wax, and the like.

In a particularly preferred embodiment, the invention comprises a sugar shell with a colored polished, non-porous hydrophobic background surface, a primary image in color, printed in one or more piezo jet compatible water-based inks, a colored enhanced perimeter forming a border around at least a portion of the primary image, the border narrow with respect to the primary image, wherein the color of the enhanced perimeter, the color of the background surface and the color of the primary image are all different. The perimeter can be formed using bands of colors, which can be in the color of the primary image or background.

The present invention also includes a method for making a decorated edible product, comprising the steps of: (a) providing an intermediate product having a surface; (b) printing an edible image on at least a portion of the surface of the intermediate product; and (c) applying an image enhancing border on at least a portion of the surface of the intermediate product, wherein the border is positioned within or adjacent to the edible image. Note that steps (b) and (c) may be carried out in reverse order or simultaneously.

The edible product may have many shapes and forms. It may be planar or nonplanar. In a preferred embodiment, the product is substantially lentil shaped. An example of a lentil shaped confectionery product is M&M's® Milk Chocolate Candies.

It is also desirable that the product be conveniently sized to be portable. In one embodiment, the product is bite sized. The term “bite sized” is used herein to denote products that resemble and/or are similar to normal sized products, but are sized so that the whole product or most of the product can be conveniently placed inside a consumer's mouth. Bite sized products often tend to be about 0.2 cm to about 3 cm in length. In another embodiment, the product is substantially lentil shaped with a diameter of about 1 cm to about 0.2 cm and has a thickness of about 0.3 cm to about 0.5 cm.

In a particularly preferred embodiment, the edible product is a confectionery product that may or may not contain chocolate. Non-limiting examples include M&M'S® Milk Chocolate Candies, M&M'S® Peanut Chocolate Candies, SKITTLES®, and STARBURST®, jellybeans, Hershettes®, Smarties®, Reese's pieces®, jelly bellies, Mike N Ike®, Hershey Bites®, Malteasers®, and the like.

### EXAMPLE 1

A product having a red colored background and a pink colored image is provided. In the presence of the red background, the pink appears too light (high Value) and is more saturated when compared to its ‘true color.’ By placing a black colored border around the image, the pink will look like it is darker (decreased Value and decreased saturation) moving it closer to its ‘true color.’

### EXAMPLE 2

A product having a red colored background and a blue colored image is provided. In the presence of the red background, the blue looks lighter than the ‘true color’ (increased Value) with a somewhat diminished saturation. Using a light grey border, the blue image appears to have a lighter color (increased Value) and increased saturation, moving it closer to its ‘true color.’

### EXAMPLE 3

In accordance to Example 1, a product having a red colored background and a pink colored image is provided. In the presence of the red background, the pink appears too light (high Value) and is more saturated when compared to its ‘true color.’ A red colored border of the same hue as the background but having a higher value, is placed around the image. The higher value of the red border makes it appear lighter than the red background. The result is that the pink image will look like it is darker (decreased Value and decreased saturation) moving it closer to its ‘true color.’

### EXAMPLE 4

In accordance to Example 2, a product having a red colored background and a blue colored image is provided. In the presence of the red background, the blue appears lighter (high Value) and is more saturated when compared to its ‘true color.’ A red colored border of the same hue as the background but having a lower value, is placed around the image. The lower value of the red border makes it appear lighter than the red background. The result is that the blue image will look like it is darker (increased Value and increased saturation) moving it closer to its ‘true color.’

Examples 3 and 4 demonstrate that perceived color enhancement may be obtained by using a border color of the same hue as the background, but having a different value (relative lightness or darkness). Proper adjustment of the value will provide the desired contrasting effect.

While the invention has been described above with reference to specific embodiments thereof, it is apparent that many changes, modifications, and variations can be made without departing from the inventive concept disclosed herein. Accordingly, it is intended to embrace all such changes, modifications, and variations that fall within the spirit and broad scope of the appended claims. All patent applications, patents, and other publications cited herein are incorporated by reference in their entirety.

1. A decorated edible product comprising:
an intermediate product having a surface, an edible image printed on said surface of said intermediate product, and an image enhancing border positioned within or adjacent to said edible image.

2. The product of claim 1, wherein said border is a gray scaled color.

3. The product of claim 1, wherein said border substantially surrounds said edible image.

4. The product of claim 1, wherein said border is substantially surrounded by said edible image.

5. The product of claim 1, wherein said border fades into said edible image.

6. The product of claim 1, wherein said border fades into a background.

7. The product of claim 1, wherein
(a) said edible image is a light colored image surrounded by a light colored background and said border is a dark color, or
(b) said edible image is a dark colored image surrounded by a light colored background and said border is a dark color, or
(c) said edible image is a dark colored image surrounded by a dark colored background and said border is a light color, or
(d) said edible image is a light colored image surrounded by a dark colored background and said border is a light color.

8. (canceled)

9. (canceled)

10. (canceled)

11. The product of claim 1, wherein said border is a color different from said edible image.

12. The product of claim 1, wherein said border is comprised of one or more colors.

13. The product of claim 1, wherein said border is patterned.

14. The product of claim 1, wherein said edible image is applied using piezo jet printing.

15. The product of claim 1, wherein said border is vignetted and has a resolution of about 400 dpi to about 10 dpi.

16. (canceled)

17. (canceled)

18. The product of claim 1, wherein said intermediate product surface is a hydrophobic based material selected from the group consisting of carnuba wax, candelilla wax, beeswax, fat, and mixtures thereof.

19. The product of claim 1, wherein said product is a confectionery product.

20. (canceled)

21. The product of claim 1, further comprising a sugar shell with a colored polished, non-porous hydrophobic intermediate product surface, an edible image in color, printed in one or more piezo jet compatible water-based inks, an image enhancing border forming a border around at least a portion of said edible image, wherein the color of said border, the color of said intermediate product surface and the color of said edible image are all different.

22. A method of making a decorated edible product, comprising the steps of:
(a) providing an intermediate product;
(b) printing an edible image on at least a portion of a surface of said intermediate product; and
(c) applying an image enhancing border on at least a portion of said surface of said intermediate product, wherein said border is positioned within or adjacent to said edible image.

23. The method of claim 22, wherein said edible image is applied by piezo jet printing.

24. The method of claim 22, wherein said border has a resolution of about 400 dpi to about 10 dpi.

25. The method of claim 22, further comprising a step of applying a protective coating that covers at least a portion of said edible image and at least a portion of said border.

26. The method of claim 22, wherein said step (c) of applying a border comprises applying ink from a piezo jet printhead having a white pigmented edible ink reservoir and at least one non-pigmented edible ink reservoir.
